(19) United States
(12) Patent Application Publication
(10) Pub. No.: US 2024/0351077 A1
(43) Pub. Date: Oct. 24, 2024

(54) VIBRATION DEVICE AND VIBRATION METHOD

(71) Applicant: Murata Manufacturing Co., Ltd., Nagaokakyo-shi (JP)

(72) Inventors: Yuka TANAKA, Nagaokakyo-shi (JP); Noritaka KISHI, Nagaokakyo-shi (JP); Takahide NAKADOI, Nagaokakyo-shi (JP); Katsuhiro TABUCHI, Nagaokakyo-shi (JP)

(21) Appl. No.: 18/762,163

(22) Filed: Jul. 2, 2024

Related U.S. Application Data
(63) Continuation of application No. PCT/JP2022/035930, filed on Sep. 27, 2022.

(30) Foreign Application Priority Data
Feb. 16, 2022 (JP) 2022-022284

(51) Int. Cl. B08B 7/02; B60S 1/56; G02B 27/00; H04N 23/81

(52) U.S. Cl. CPC B08B 7/02; H04N 23/811; B60S 1/56; G02B 27/0006

(57) ABSTRACT

A vibration device includes a light transmitter, a vibrator to vibrate the light transmitter, a driver to drive the vibrator, and a controller configured or programmed to control the driver and determine a high-frequency-band resonant frequency of the vibrator according to a state of the driver obtained by changing a drive frequency of the driver within a high frequency band higher than or equal to about 100 kHz, and estimate a temperature of the light transmitter from the determined high-frequency-band resonant frequency.

### CROSS REFERENCE TO RELATED APPLICATIONS

This application claims the benefit of priority to Japanese Patent Application No. 2022-022284 filed on Feb. 16, 2022 and is a Continuation application of PCT Application No. PCT/JP2022/035930 filed on Sep. 27, 2022. The entire contents of each application are hereby incorporated herein by reference.

### BACKGROUND OF THE INVENTION

### 1. Field of the Invention

The present disclosure relates to vibration devices and vibration methods.

### 2. Description of the Related Art

A technology involving an imaging device located on an exterior of a vehicle and using captured images to perform control of a safety device, control of automated driving, and the like is known. As for such an imaging device, foreign matter such as mud, dust, raindrops, snow, ice, and frost is sometimes attached to a light transmitter, such as a lens and a protective cover, that covers the outside of the imaging device. If foreign matter is attached to the light transmitter, the foreign matter is included in captured images, and clear images cannot be captured.

Japanese Unexamined Patent Application Publication No. 2011-517417 discloses a technique of vibrating a lens at a first frequency (a cleaning mode) and a technique of vibrating the lens at a second frequency (a heating mode) to heat the lens in cold weather, in order to remove foreign matter attached to the lens. In the technique described in Japanese Unexamined Patent Application Publication No. 2011-517417, to determine whether to heat the lens, the temperature of the lens is estimated by measuring the impedance response of a lens cover system.

However, the impedance related to the vibration of the light transmitter is dependent on not only the temperature of the light transmitter but also the amount of the foreign matter attached to the light transmitter. Thus, the temperature of the light transmitter cannot be accurately estimated in some cases by the measurement of the impedance response.

### SUMMARY OF THE INVENTION

Example embodiments of the present invention provide vibration devices and vibration methods that each enable a temperature of a light transmitter to be estimated more accurately than in conventional techniques.

A vibration device according to an example embodiment of the present invention includes a light transmitter, a vibrator to vibrate the light transmitter, a driver to drive the vibrator, and a controller configured or programmed to control the driver and to determine a high-frequency-band resonant frequency of the vibrator, according to a state of the driver obtained by changing a drive frequency of the driver within a high frequency band higher than or equal to about 100 kHz, and estimate a temperature of the light transmitter from the determined high-frequency-band resonant frequency.

A vibration method according to an example embodiment of the present invention is a vibration method performed by a vibration device including a light transmitter, a vibrator to vibrate the light transmitter, a driver to drive the vibrator, and a controller configured or programmed to control the driver, the vibration method includes determining, in the controller, a high-frequency-band resonant frequency of the vibrator, according to a state of the driver obtained by changing a drive frequency of the driver within a high frequency band higher than or equal to about 100 kHz, and estimating, in the controller, a temperature of the light transmitter from the determined high-frequency-band resonant frequency.

With vibration devices and vibration methods according to example embodiments of the present invention, it is possible to estimate the temperature of a light transmitter more accurately than conventional techniques.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of an imaging unit according to an example embodiment of the present invention, illustrating a configuration example.

FIG. 2 is a cross-sectional view of the imaging unit in FIG. 1.

FIG. 3 is a block diagram illustrating an example of a hardware configuration of an imaging unit according to an example embodiment of the present invention.

FIG. 4 is a flowchart for explaining an operation example of an imaging unit according to an example embodiment of the present invention.

FIG. 5 is a graph illustrating the relationship between a resonant frequency in a low frequency band, impedance, and temperature of a vibrator.

FIG. 6A is a graph illustrating the relationship between a resonant frequency of a vibrator in a low frequency band and temperature.

FIG. 6B is a graph illustrating the relationship between a minimum impedance of a piezoelectric vibrator in the low frequency band and temperature.

FIG. 7A is a graph illustrating the relationship between an amount of attached water which is an example of foreign matter and a resonant frequency of a vibrator in a low frequency band.

FIG. 7B is a graph illustrating the relationship between an amount of attached water which is an example of foreign matter and an impedance of a piezoelectric vibrator in a low frequency band.

FIG. 8A is a graph illustrating the relationship between a resonant frequency of a vibrator in a high frequency band and temperature.

FIG. 8B is a graph illustrating the relationship between a minimum impedance of a piezoelectric vibrator in a high frequency band and temperature.

FIG. 9A is a graph illustrating the relationship between an amount of attached water which is an example of foreign matter and a resonant frequency of a vibrator in a high frequency band.

FIG. 9B is a graph illustrating the relationship between an amount of attached water which is an example of foreign matter and an impedance of the piezoelectric vibrator in a high frequency band.

FIG. 10 is a flowchart for explaining an example of a temperature estimation operation in FIG. 4.

FIG. 11 is a schematic timing chart for explaining a heating operation in an imaging unit according to an example embodiment of the present invention.

### DETAILED DESCRIPTION OF THE EXAMPLE EMBODIMENTS

A vibration device according to an example embodiment of the present invention includes a light transmitter, a vibrator to vibrate the light transmitter, a driver to drive the vibrator, and a controller configured or programmed to control the driver and to determine a high-frequency-band resonant frequency of the vibrator, according to a state of the driver obtained by changing a drive frequency of the driver within a high frequency band higher than or equal to about 100 kHz, and estimate the temperature of the light transmitter from the determined high-frequency-band resonant frequency.

This configuration enables the temperature of the light transmitter to be estimated more accurately than in conventional techniques.

In the vibration device, if the estimated temperature of the light transmitter is lower than a specified value, the controller may be configured or programmed to control the driver such that the driver causes the vibrator to vibrate at a high frequency of about 100 kHz or higher, and, if the estimated temperature of the light transmitter is higher than or equal to the specified value, the controller may determine a low-frequency-band resonant frequency of the vibrator, according to a state of the driver obtained by changing the drive frequency of the driver within a low frequency band lower than about 100 kHz and control the driver such that the driver causes the vibrator to vibrate at the determined low-frequency-band resonant frequency.

This configuration enables the temperature of the light transmitter to increase as necessary and also makes it easy to remove the foreign matter attached to the light transmitter.

In the vibration device, if the estimated temperature of the light transmitter is lower than a specified value, the controller may determine again a high-frequency-band resonant frequency of the vibrator, according to a state of the driver obtained by changing the drive frequency of the driver within the high frequency band, estimate again the temperature of the light transmitter from the high-frequency-band resonant frequency determined again, and, if the temperature of the light transmitter estimated again is lower than the specified value, the controller may repeat controlling the driver such that the driver causes the vibrator to vibrate at a frequency in the high frequency band for a specified period, after the specified period, determining again a high-frequency-band resonant frequency of the vibrator according to a state of the driver obtained by changing the drive frequency of the driver within the high frequency band, and estimating again the temperature of the light transmitter from the high-frequency-band resonant frequency determined again, until the temperature of the light transmitter estimated again becomes higher than or equal to the specified value.

This configuration enables the temperature of the light transmitter to increase further as necessary and also makes it easy to remove the foreign matter attached to the light transmitter.

In the vibration device, if the temperature of the light transmitter estimated again has become higher than or equal to the specified value, or if the estimated temperature of the light transmitter is higher than or equal to the specified value, the controller may determine a low-frequency-band resonant frequency of the vibrator, according to a state of the driver obtained by changing the drive frequency of the driver within a low frequency band lower than about 100 kHz and control the driver such that the driver causes the vibrator to vibrate at the determined low-frequency-band resonant frequency.

In the case in which the temperature of the light transmitter has become higher than or equal to the specified value, this configuration makes it easy to remove the foreign matter attached to the light transmitter.

The vibration device may further include a temperature sensor to measure the temperature of the light transmitter, and, if the temperature of the light transmitter measured by the temperature sensor is higher than or equal to the specified value, the controller may determine the low-frequency-band resonant frequency of the vibrator, according to a state of the driver obtained by changing the drive frequency of the driver within a low frequency band lower than 100 kHz and control the driver such that the driver causes the vibrator to vibrate at the determined low-frequency-band resonant frequency.

This configuration enables the temperature of the light transmitter to be controlled more accurately and makes it easier to remove the foreign matter attached to the light transmitter.

In the vibration device, the light transmitter may be located in a field of view of an imaging device, and the controller may obtain a captured image from the imaging device and execute image processing on the captured image, and if a result of the image processing indicates that foreign matter is not attached to a surface of the light transmitter, the controller may determine the low-frequency-band resonant frequency of the vibrator, according to a state of the driver obtained by changing the drive frequency of the driver within a low frequency band lower than 100 kHz and control the driver such that the driver causes the vibrator to vibrate at the determined low-frequency-band resonant frequency.

This configuration makes it possible to determine more accurately whether foreign matter is attached to the light transmitter and makes it easier to remove the foreign matter attached to the light transmitter.

In the vibration device, the controller may be configured or programmed to measure a drive current of the driver while changing the drive frequency of the driver within the low frequency band, and determine the low-frequency-band resonant frequency according to the measured drive current value.

This configuration makes it possible to determine a low-frequency-band resonant frequency accurately and makes it easier to remove the foreign matter attached to the light transmitter.

In the vibration device, the controller may be configured or programmed to measure a drive current of the driver while changing the drive frequency of the driver within the high frequency band, and determine the high-frequency-band resonant frequency according to the measured drive current value.

This configuration makes it possible to determine a high-frequency-band resonant frequency accurately and enables the temperature of the light transmitter to be estimated more accurately than in conventional techniques.

In the vibration device, the controller may estimate the temperature T of the light transmitter by using expression (1):

$$T = A \cdot fr + B , \qquad ( 1 )$$

where A is a constant smaller than 0, B is a constant larger than 0, and fr is a resonant frequency of the vibrator.

This configuration enables the temperature of the light transmitter to be estimated more accurately.

A vibration method according to an example embodiment of the present vibration method performed by a vibration device including a light transmitter, a vibrator to vibrate the light transmitter, a driver to drive the vibrator, and a controller configured or programmed to control the driver, and the vibration method includes determining, in the controller, a high-frequency-band resonant frequency of the vibrator, according to a state of the driver obtained by changing a drive frequency of the driver within a high frequency band higher than or equal to about 100 kHz, and estimating, in the controller, the temperature of the light transmitter from the determined high-frequency-band resonant frequency.

With the vibration method described above, it is possible to estimate the temperature of the light transmitter more accurately than conventional techniques.

Hereinafter, vibration devices according to example embodiments of the present invention will be described with reference to the attached drawings. In the following example embodiments, the same or similar elements are denoted by the same symbols. To facilitate understanding of explanation, the shape, dimensions, positional relationship, and the like of each element are sometimes exaggerated in the attached drawings.

### 1. Configuration

### 1-1. Overall Configuration

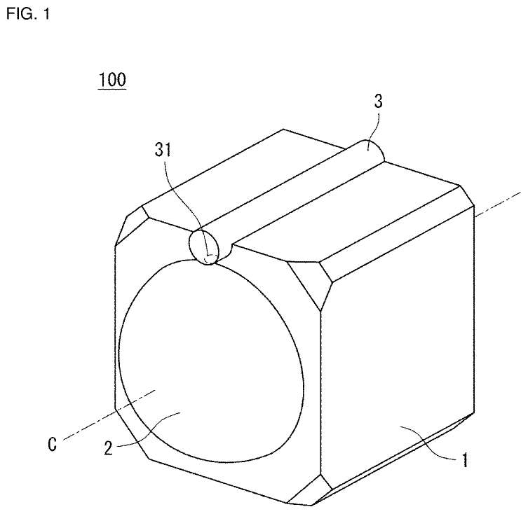

FIG. 1 is a perspective view of an imaging unit 100 according to an example embodiment of the present invention, illustrating a configuration example.

FIG. 1 includes an imaginary axis C for convenience of explanation. In the present specification, the direction parallel or substantially parallel to the axis C is referred to as the axial direction, a direction perpendicular or substantially perpendicular to the axis C is referred to as a radial direction, and the direction of the circumference of a circle centered on the axis C is referred to as a circumferential direction. As for the axial direction, the leftward direction on the drawing plane in FIG. 1 is defined as the positive direction. The positive axial direction is also referred to as the distal direction, and the negative axial direction is also referred to as the proximal direction. As for a radial direction, a direction away from the axis C is sometimes referred to as an outward direction, and a direction toward the axis C is sometimes referred to as an inward direction.

The imaging unit 100 includes a housing 1, a transparent protective cover 2 located on one surface of the housing 1, and a cleaning nozzle 3. The cleaning nozzle 3 includes an opening 31 to eject a cleaning liquid (cleaner) toward the protective cover 2.

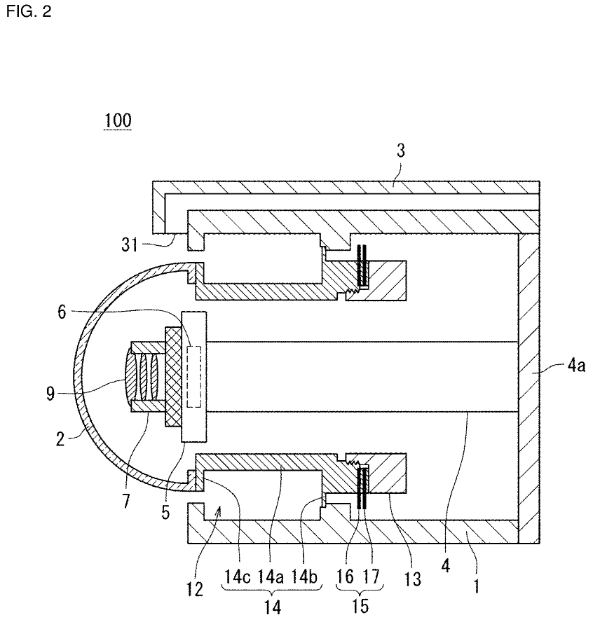

FIG. 2 is a cross-sectional view of the imaging unit 100 in FIG. 1. The imaging unit 100 further includes a vibrator 12 to vibrate the protective cover 2, and an imaging device 5.

The imaging unit 100 includes a component (the imaging device 5) to capture images, a component (a vibration device) to vibrate the protective cover 2 to remove the foreign matter attached to the protective cover 2, and a component (a cleaning device) to eject a cleaning liquid toward the protective cover 2 to remove the foreign matter attached to the protective cover 2. The cleaning nozzle 3 is an example of the cleaning device.

In FIG. 2, a base plate 4a is fixed to one end side of the housing 1, and the protective cover 2 and the vibrator 12 are located on the other end side of the housing 1. The imaging device 5 is supported by a cylindrical body 4 and fixed to the base plate 4a.

The imaging device 5 includes a circuit 6 including an imaging element. A lens module 7 is fixed in the image-capturing direction relative to the imaging device 5. The lens module 7 includes a cylindrical member in which a plurality of lenses 9 are aligned in the axial direction. However, the structure of the imaging device 5 is not limited to this one. The imaging device 5 may have any structure capable of capturing images of a subject ahead of (on the distal end portion side relative to) the lenses 9.

The vibrator 12 includes a first cylindrical member 13 centered on the axis C and having a cylindrical shape, a second cylindrical member 14 centered on the axis C and having a cylindrical shape, and a piezoelectric vibrator 15 centered on the axis C and having a cylindrical shape. The vibrator 12 is an example of a vibration unit. The piezoelectric vibrator 15 is located between the first cylindrical member 13 and the second cylindrical member 14.

The piezoelectric vibrator 15 includes cylindrical piezoelectric plates 16 and 17. Each of the piezoelectric plates 16 and 17 can be polarized in the axial direction. The polarization direction of the piezoelectric plate 16 is opposite to the polarization direction of the piezoelectric plate 17.

The piezoelectric plates 16 and 17 include, for example, a PZT-based piezoelectric ceramic, (K, Na) NbO₃ piezoelectric ceramic, or LiTaO₃ piezoelectric single crystal. Each of the piezoelectric plates 16 and 17 includes electrodes (not illustrated). These electrodes have, for example, a stack structure of Ag/NiCu/NiCr.

The first cylindrical member 13 and the second cylindrical member 14 are made of, for example, a metal such as duralumin, stainless steel, and kovar or a semiconductor having conductivity such as Si.

When an alternating current electric field is applied to the electrodes of each of the piezoelectric plates 16 and 17, the piezoelectric vibrator 15 can vibrate in the longitudinal direction or a lateral direction. The first cylindrical member 13 includes an outer thread portion on at least a portion of the outer surface, and the second cylindrical member 14 includes an inner thread portion on at least a portion of the inner surface. With these threads, the first cylindrical member 13 is screwed into and fixed to the second cylindrical member 14. This screwing makes a portion of the first cylindrical member 13 and a portion the second cylindrical member 14 be in pressure contact with one surface and the other surface of the piezoelectric vibrator 15, respectively.

Thus, the vibration generated in the piezoelectric vibrator 15 causes the entire vibrator 12 to be vibrated efficiently. In the present example embodiment, the vibrator 12 is efficiently excited by the longitudinal effect or the transverse effect.

The second cylindrical member 14 includes a cylindrical thin-material-thickness portion 14a and flange portions 14b and 14c. The flange portion 14c is located at the distal end of the second cylindrical member 14 and protrudes outward from the thin-material-thickness portion 14a. The flange portion 14b is located on the proximal end portion side of the second cylindrical member 14 relative to the flange portion 14c and protrudes outward from the thin-material-thickness portion 14a. The thin-material-thickness portion 14a is thinner than the first cylindrical member 13. Accordingly, the cylindrical thin-material-thickness portion 14a is largely displaced by the vibration of the vibrator 12, which magnifies the vibration, in particular, the amplitude.

The protective cover 2 is fixed to the flange portion 14c. In the present example embodiment, the protective cover 2 has a hemispherical shape. The protective cover 2 is an example of a light transmitter which light from the subject passes through. The material of the protective cover 2 is, for example, soda-lime glass, borosilicate glass, aluminosilicate glass, or a combination of some of these. The protective cover 2 may be, for example, toughened glass strengthened by chemical strengthening or the like. The surface of the protective cover 2 may be coated with, for example, an anti-reflection film, a water-repellent material, an impact resistant material, or the like.

The cleaning nozzle 3 is configured such that a cleaning liquid supplied from the proximal end portion side passes through an internal tube extending in the axial direction and the opening 31 and is ejected to the protective cover 2. The distal end of the cleaning nozzle 3 is located outside the image capturing range (field of view) of the imaging device 5 and is not at a position where it is taken in the images captured by the imaging device 5. Although the present example embodiment illustrates a configuration in which the imaging unit 100 includes one cleaning nozzle 3, the imaging unit 100 may include two or more cleaning nozzles 3.

### 1-2. Hardware Configuration

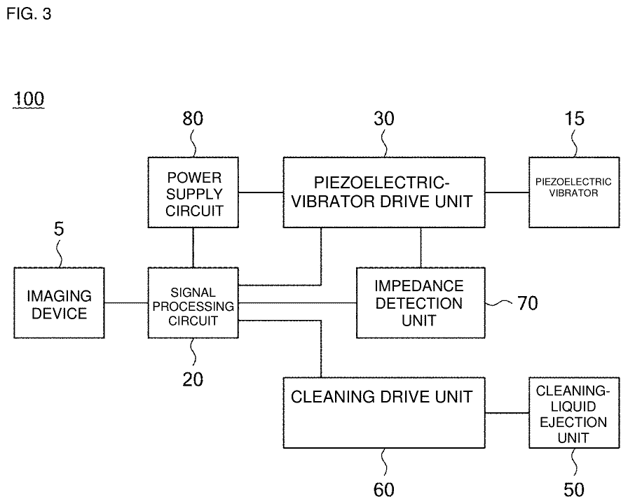

FIG. 3 is a block diagram illustrating an example of the hardware configuration of the imaging unit 100. The imaging unit 100 further includes a signal processing circuit 20, a piezoelectric-vibrator driver 30, a cleaning-liquid ejector 50, a cleaning driver 60, an impedance detector 70, and a power supply circuit 80.

The signal processing circuit 20 is a controller that processes the signal from the imaging device 5 and supplies the imaging device 5, the piezoelectric-vibrator driver 30, and the cleaning driver 60 with control signals. Such information processing is implemented, for example, by the signal processing circuit 20 operating according to instructions in a program.

The signal processing circuit 20 includes a central processing unit (CPU), read only memory (ROM), random access memory (RAM), an input and output interface to maintain signal matching with signals of peripheral devices, and the like. The ROM stores, for example, a program, and control data, and the like for the CPU to operate. The RAM defines and functions as a work area for the CPU.

The piezoelectric-vibrator driver 30 generates an alternating-current output signal according to a control signal from the signal processing circuit 20 and transmits it to the piezoelectric vibrator 15. The alternating-current output signal includes, for example, information on frequency and voltage. The piezoelectric vibrator 15 vibrates according to the received alternating-current output signal and vibrates the vibrator 12 and the protective cover 2.

The cleaning driver 60 causes the cleaning-liquid ejector 50 to supply the cleaning liquid according to a control signal from the signal processing circuit 20. The supplied cleaning liquid is ejected to the protective cover 2 through the opening 31 of the cleaning nozzle 3.

The impedance detector 70, when the piezoelectric-vibrator driver 30 is applying an alternating-current output signal to the piezoelectric vibrator 15 to operate the piezoelectric vibrator 15, monitors electrical characteristics such as the drive current, impedance, and the like of the piezoelectric-vibrator driver 30. The impedance detector 70 is an example of a controller. The impedance detector 70 may be a unit separate from the signal processing circuit 20 as in FIG. 3 or may have a unitary structure with the signal processing circuit 20.

### 2. Operation

### 2-1. Overall Operation

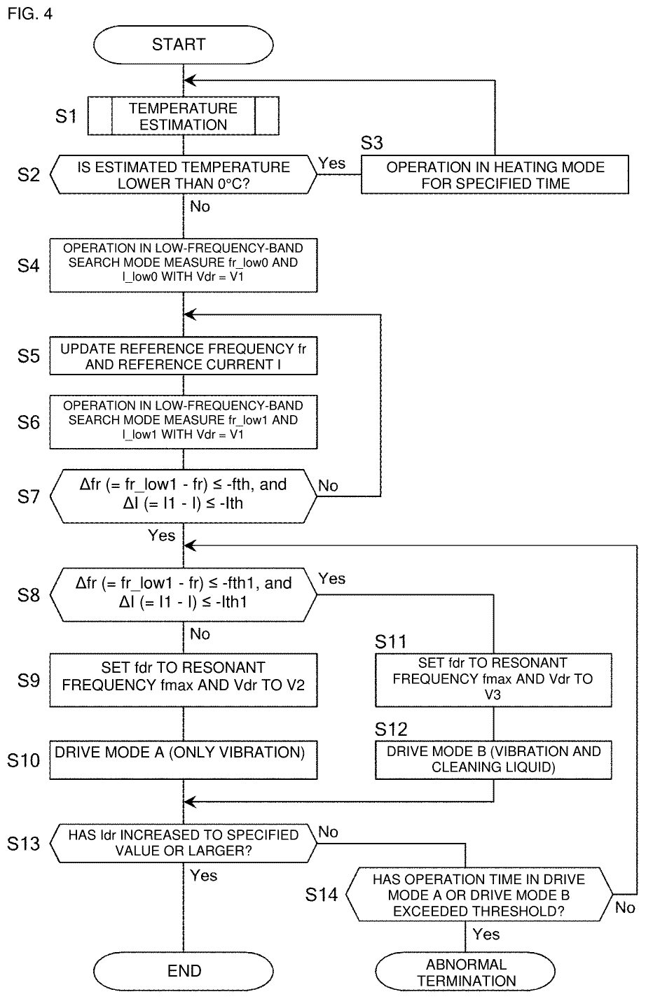

FIG. 4 is a flowchart for explaining an operation example of the imaging unit 100. The operation in FIG. 4 is executed by the signal processing circuit 20.

First, the signal processing circuit 20 estimates the temperature of the protective cover 2 from the drive current of the piezoelectric-vibrator driver 30 (S1). Details of the temperature estimation step S1 will be described later.

Next, the signal processing circuit 20 determines whether the temperature estimated in step S1 is, for example, lower than about 0° C. which is a lower-limit threshold (S2). The lower-limit threshold is not limited to about 0° C. and may be set to a temperature selected in advance from, for example, the range of −about 4° C. to about +4° C.

If the temperature estimated in step S1 is lower than about 0° C. (Yes at S2), the signal processing circuit 20 causes the piezoelectric-vibrator driver 30 to operate the piezoelectric vibrator 15 in a heating mode for a specified time (S3). The heating mode is a mode in which the piezoelectric vibrator 15 vibrates at a frequency in a high frequency band, and the vibration increases the temperature of the protective cover 2. The signal processing circuit 20, after finishing step S3, returns the process to S1.

If the temperature estimated in step S1 is not lower than about 0° C. (No at S2), in other words, about 0° C. or higher, the signal processing circuit 20 operates the piezoelectric vibrator 15 in a low-frequency-band search mode (S4).

The low-frequency-band search mode in step S4 is a mode for searching for a resonant frequency of the vibrator 12 in a low frequency band (hereinafter referred to as “low-frequency-band resonant frequency”). In the present specification, for example, low frequency denotes the frequencies lower than about 100 kHz, and high frequency denotes the frequencies higher than or equal to about 100 kHz. In the low-frequency-band search mode, the piezoelectric-vibrator driver 30 sets the drive voltage Vdr of the piezoelectric vibrator 15 to V1 and applies alternating-current output signals to the piezoelectric vibrator 15 while changing the drive frequency f to perform sweeping.

During the low-frequency-band search mode in step S4, the impedance detector 70 monitors the current value or the impedance of the piezoelectric-vibrator driver 30. Specifically, the impedance detector 70 measures the value of the current flowing in the piezoelectric-vibrator driver 30 or the impedance which is the reciprocal of the current value. The signal processing circuit 20 obtains the drive frequency f and the current value or impedance and determines the drive frequency f at which the current value becomes the maximum value I_low0 or the drive frequency f at which the impedance becomes minimum, as the initial resonant frequency fr_low0. In this way, the signal processing circuit 20 measures the maximum current value I_low0 and the initial resonant frequency fr_low0 corresponding to the maximum current value I_low0.

The signal processing circuit 20 updates memory such that the reference frequency fr and the reference current value I are respectively set to the initial resonant frequency fr_low0 and current value I_low0 measured in step S4 (step S5).

Next, the signal processing circuit 20 operates the piezoelectric vibrator 15 in the low-frequency-band search mode and measures the maximum current value I_low1 and the resonant frequency fr_low1 corresponding to the maximum current value I_low1 (S6) by a method the same as or similar to the one in step S4. Step S6 is executed, for example, after a specified time following step S4, for example, after one second following step S4.

The signal processing circuit 20 calculates the difference value Δfr between the resonant frequency fr_low1 and the reference frequency fr and the difference value ΔI (=I_low1−I) between the maximum current value I_low1 and the reference current value I, and determines whether the difference values Δf and ΔI are smaller than or equal to first thresholds (S7). Specifically, the signal processing circuit 20 determines whether the difference value Δf (=fr_low1−fr)≤−fth, and ΔI (=I_low1−I)≤−Ith.

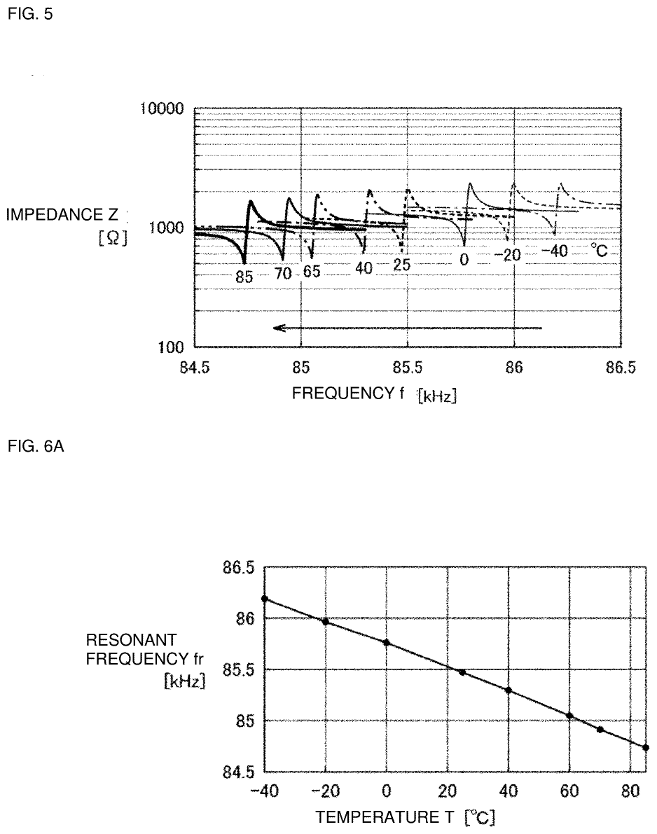

Now, the relationship between the low-frequency-band resonant frequency and temperature will be explained. FIG. 5 is a graph illustrating the relationship between the low-frequency-band resonant frequency, impedance, and temperature of the vibrator 12. In the graph of FIG. 5, the horizontal axis represents frequency [kHz], and the vertical axis represents impedance [Q]. The graph of FIG. 5 illustrates how the low-frequency-band resonant frequency changes when temperature is changed from, for example, about-40° C. to about 85° C. In the graph of FIG. 5, a frequency at which the impedance sharply changes is a low-frequency-band resonant frequency. As can be seen from the graph of FIG. 5, the low-frequency-band resonant frequency decreases with increasing temperature.

Meanwhile, the low-frequency-band resonant frequency decreases as the amount or the weight of foreign matter attached to the surface of the protective cover 2 increases. In other words, a decrease in the low-frequency-band resonant frequency is caused not only by increasing temperature but also foreign matter being attached. Thus, it is impossible to distinguish foreign matter having been attached to the surface of the protective cover 2 and a change in temperature when making a determination, only by measuring changes in the low-frequency-band resonant frequency with the impedance detector 70.

In particular, in the case in which the signal processing circuit 20 makes a determination only with reference to the low-frequency-band resonant frequency, there is a possibility that when the low-frequency-band resonant frequency decreases actually due to an increase in the temperature, the signal processing circuit 20 can erroneously recognize that the decrease is caused by foreign matter been attached to the surface of the protective cover 2. In the case in which the signal processing circuit 20 erroneously recognized that a decrease in the low-frequency-band resonant frequency was caused by foreign matter attached to the surface of the protective cover 2, the signal processing circuit 20 would perform control to increase the amplitude of the vibration of the piezoelectric vibrator 15 to remove the foreign matter. If the amplitude of the vibration of the piezoelectric vibrator 15 is increased, the surface of the temperature of the protective cover 2 would further increase. In the case in which foreign matter is attached to the surface of the protective cover 2, the operation of the signal processing circuit 20 would be more unstable, and it would be difficult for the signal processing circuit 20 to make a correct determination.

The change in the low-frequency-band resonant frequency is caused not only by changes in the temperature but also by changes over time in the joint portion between the protective cover 2 and the vibrator 12, moisture absorption of resin portions, and other factors. Thus, the signal processing circuit 20 may take into account not only changes in the low-frequency-band resonant frequency but also other information to determine that foreign matter has been attached to the surface of the protective cover 2.

As can be seen from the graph of FIG. 5, as the temperature changes from about −40° C. to about 85° C., for example, not only the low-frequency-band resonant frequency decreases, but also the minimum value of the impedance decreases. To makes it easy to understand this relationship, explanation will be made by separating the relationship into a graph of changes in the low-frequency-band resonant frequency with temperature and a graph of changes in the minimum value of the impedance with temperature.

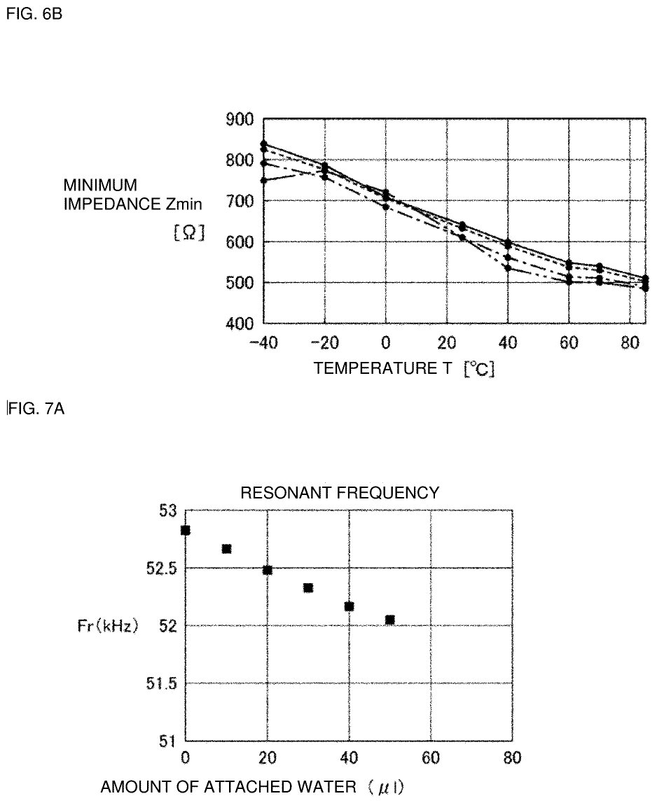

FIG. 6A is a graph illustrating the relationship between the low-frequency-band resonant frequency and temperature. In FIG. 6A, the horizontal axis represents temperature [° C.], and the vertical axis represents the low-frequency-band resonant frequency [kHz]. As can be seen from the graph of FIG. 6A, the low-frequency-band resonant frequency decreases with increasing temperature.

FIG. 6B is a graph illustrating the relationship between the minimum impedance (the minimum value of the impedance) of the piezoelectric vibrator 15 in the low frequency band and temperature. In FIG. 6B, the horizontal axis represents temperature [° C.], and the vertical axis represents the minimum impedance [2]. As can be seen from the graph of FIG. 6B, the minimum impedance of the piezoelectric vibrator 15 in the low frequency band decreases with increasing temperature.

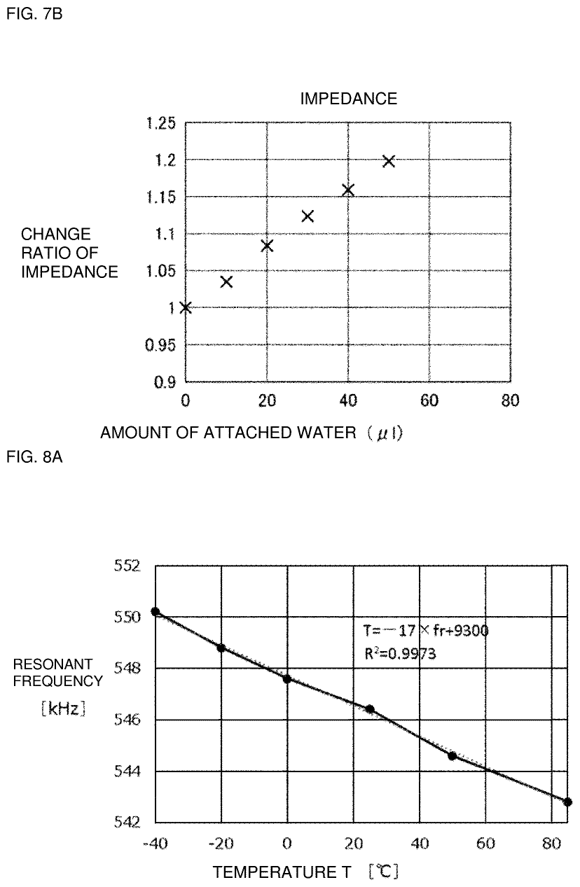

Next, with reference to FIGS. 7A and 7B, a description will be provided of changes in the low-frequency-band resonant frequency and the minimum value of the impedance when foreign matter is attached to the surface of the protective cover 2.

FIG. 7A is a graph illustrating the relationship between the amount of attached water which is an example of foreign matter and the low-frequency-band resonant frequency. In FIG. 7A, the horizontal axis represents the volume of the water attached to the surface of the protective cover 2 (hereinafter referred to as “the amount of attached water”) [μl], and the vertical axis represents the low-frequency-band resonant frequency [KHz]. As can be seen from the graph illustrated in FIG. 7A, the low-frequency-band resonant frequency decreases as the amount of attached water increases.

FIG. 7B is a graph illustrating the relationship between the amount of attached water which is an example of foreign matter and the minimum impedance of the piezoelectric vibrator 15 in the low frequency band. In FIG. 7B, the horizontal axis represents the amount of attached water [μl], and the vertical axis represents the change ratio of the impedance. As can be seen from the graph illustrated in FIG. 7B, the change ratio of the minimum impedance of the piezoelectric vibrator 15 increases as the amount of attached water increases. In contrast, the change ratio of the current value I corresponding to the minimum impedance of the piezoelectric vibrator 15 decreases, as the amount of attached water increases.

Using the knowledge obtained from the graphs illustrated in in FIGS. 6A, 6B, 7A, and 7B, the signal processing circuit 20 makes a determination by combining the change in the low-frequency-band resonant frequency and the change in the minimum impedance of the piezoelectric vibrator 15. This method makes it possible to accurately determine whether a change is caused by foreign matter having been attached to the surface of the protective cover 2 or by a change in the temperature. Although a change in the minimum impedance of the piezoelectric vibrator 15 occurs also due to changes over time in the joint portion between the protective cover 2 and the vibrator 12, moisture absorption of resin portions, and other factors, this change differs from the change in the case in which foreign matter is attached to the surface of the protective cover 2. Thus, it is possible to distinguish these cases when making a determination.

As described above, the low-frequency-band resonant frequency and the minimum impedance decrease with increasing temperature. In addition, as the amount of foreign matter attached to the surface of the protective cover 2 increases, the low-frequency-band resonant frequency decreases, and in contrast, the change ratio of the minimum impedance increases.

Thus, by combining changes in the low-frequency-band resonant frequency and changes in the minimum impedance or current of the piezoelectric vibrator 15, it is possible to distinguish foreign matter having been attached to the surface of the protective cover 2 and a change in the temperature when making determination. The signal processing circuit 20 executes the process corresponding to the determination described above in step S7.

Specifically, if the change (Δfr) in the decreasing resonant frequency is smaller than or equal to a first frequency threshold fth, and the change (ΔI) in the decreasing current value is smaller than or equal to a first current threshold Ith, the signal processing circuit 20 determines that foreign matter has been attached to the surface of the protective cover 2. As described above, the signal processing circuit 20 does not determine whether foreign matter is present or not on the surface of the protective cover 2 by using only the change (the change over time) in the resonant frequency, but the signal processing circuit 20 can determine whether foreign matter is present or not by also using the change (the change over time) in the current value which is a value relating to the impedance.

Returning to FIG. 4, if it is determined that the difference values Δf and ΔI are larger than the first thresholds (No at S7), the signal processing circuit 20 returns the process to step S5. In this case, it is inferred that foreign matter is not attached to the surface of the protective cover 2. In step S5 executed again, the signal processing circuit 20 updates memory such that the reference frequency fr and the reference current value I are respectively set to be the resonant frequency fr_low1 and the current value I_low1 measured in step S6.

If the difference values Δf and ΔI are smaller than or equal to the first thresholds in step S7 (Yes at S7), the signal processing circuit 20 determines whether the difference values Δf and ΔI are smaller than or equal to second thresholds which differ from the first thresholds (S8). Specifically, the signal processing circuit 20 determines whether the difference value Δf≤−fth1, and the difference value ΔI≤−Ith1. In this step, the absolute value of the second frequency threshold fth1 is larger than the absolute value of the first frequency threshold fth (fth1>fth), and the second current threshold Ith1 is larger than the first current threshold Ith (Ith1>Ith).

If the difference values Δf and ΔI are smaller than or equal to the second thresholds, the signal processing circuit 20 performs a specific process corresponding to the case in which the amount or weight of the foreign matter attached to the surface of the protective cover 2 is large or heavy (which means that the degree of the dirt on the protective cover 2 is high).

The signal processing circuit 20 determines by using the first thresholds fth and Ith whether foreign matter is attached and present on the surface of the protective cover 2, and determines by using the second thresholds fth1 and Ith1 the degree of foreign matter attached to the surface of the protective cover 2.

If it is determined in step S8 that the difference values Δf and ΔI are larger than the second thresholds (No at S8), the signal processing circuit 20 sets the drive voltage Vdr of the piezoelectric-vibrator driver 30 to V2 and sets the drive frequency fdr of the piezoelectric-vibrator driver 30 to the resonant frequency fmax (S9). In this step, V2 is larger than V1.

Next, the signal processing circuit 20 executes a drive mode A to drive only the piezoelectric-vibrator driver 30 at the drive voltage and the resonant frequency set in step S9 (S10). In the drive mode A in step S10, the signal processing circuit 20 does not drive the cleaning driver 60 and only drives the piezoelectric-vibrator driver 30.

In step S8, if the difference values Δf and ΔI are smaller than or equal to the second thresholds (Yes at S8), the signal processing circuit 20 sets the drive voltage Vdr of the piezoelectric-vibrator driver 30 to V3 and sets the drive frequency fdr of the piezoelectric-vibrator driver 30 to the resonant frequency fmax (S11). In this step, V3 is smaller than V2.

Next, the signal processing circuit 20 executes a drive mode B to not only drive the piezoelectric-vibrator driver 30 at the drive voltage and the resonant frequency set in step S11 but also drive the cleaning driver 60 (S12). Since the drive voltage V3 in the drive mode B is lower than the drive voltage V2 in the drive mode A, the piezoelectric-vibrator driver 30 in the drive mode B causes the piezoelectric vibrator 15 to vibrate less intensely than in the drive mode A.

By executing the drive mode B, the signal processing circuit 20 can more powerfully clean the protective cover 2 with the foreign matter attached to it. The signal processing circuit 20 may control the cleaning driver 60 such that the cleaning driver 60 uses more powerful cleaning power than the cleaning liquid that is ejected in the drive mode B, by using at least one of the resonant frequency, the value related to the impedance (the current value), and images captured by the imaging device 5.

After cleaning in step S10 or step S12, the signal processing circuit 20 determines whether a current value Idr measured by the impedance detector 70 has increased to a specified value or larger (S13). After the foreign matter attached to the surface of the protective cover 2 is removed, the current value Idr measured by the impedance detector 70 increases to the specified value or larger. In other words, the current value Idr measured by the impedance detector 70 approximately returns to the current value Idr at the time when foreign matter is not attached to the surface of the protective cover 2. Thus, by the signal processing circuit 20 determining whether the current value Idr measured by the impedance detector 70 has increased to the specified value or larger, it is possible to obtain information on whether the foreign matter attached to the surface of the protective cover 2 has been removed.

In step S13, if it is determined that the current value Idr has increased to the specified value or larger (Yes at S13), the signal processing circuit 20 ends the process in FIG. 4. Alternatively, in a possible configuration, the signal processing circuit 20 determines whether it has received an operation to end, and the signal processing circuit 20, if it has received the operation to end, ends the process in FIG. 4 and, if it has not received the operation to end, returns the process to step S1 or S4.

If it is determined in step S13 that the current value Idr has not increased to the specified value or larger (No at S13), the signal processing circuit 20 determines whether the operation time in the drive mode A or B has exceeded a threshold (for example, one minute) (S14). In step S14, for example, if the sum of the operation time in the drive mode A and the operation time in the drive mode B has exceeded the threshold, the signal processing circuit 20 determines that the operation time in the drive mode A or B has exceeded the threshold.

If it is determined that the operation time in the drive mode A or B has exceeded the threshold (Yes at S14), the signal processing circuit 20 determines that it is abnormal and terminates the process in FIG. 4 (abnormal termination). If the piezoelectric vibrator 15 is driven in a drive mode for cleaning for a long time, there is a possibility that a problem such as overheating of the protective cover 2 can occur. Since the signal processing circuit 20 terminates the process as an abnormal termination in a specified condition, it is possible to prevent the occurrence of such a problem.

If it is determined in step S13 that the current value Idr has not exceeded the specified value (No at S13), and if it is determined that the operation time in the drive mode A or B has not exceeded the threshold (No at S14), the signal processing circuit 20 returns the process to step S8.

### 2-2. Temperature Estimation

### 2-2-1. Knowledge Concerning Temperature Estimation

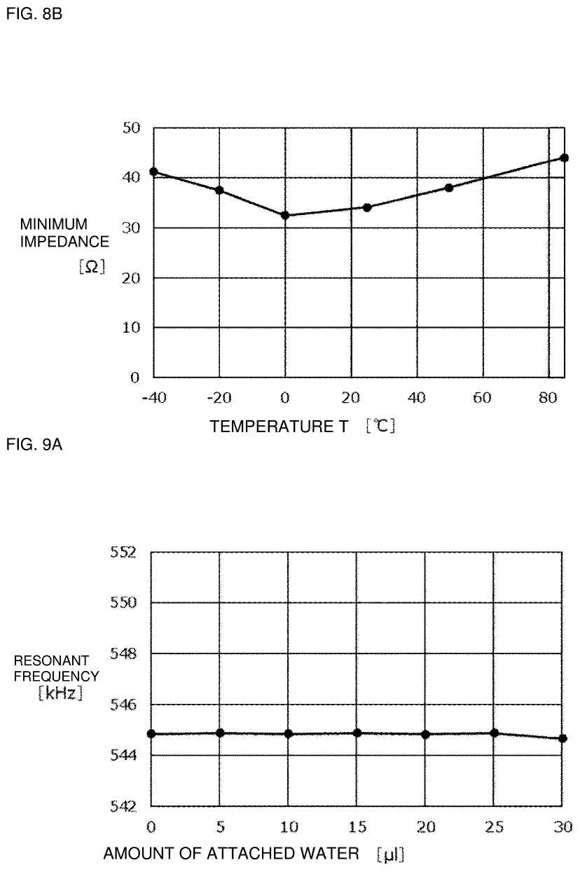

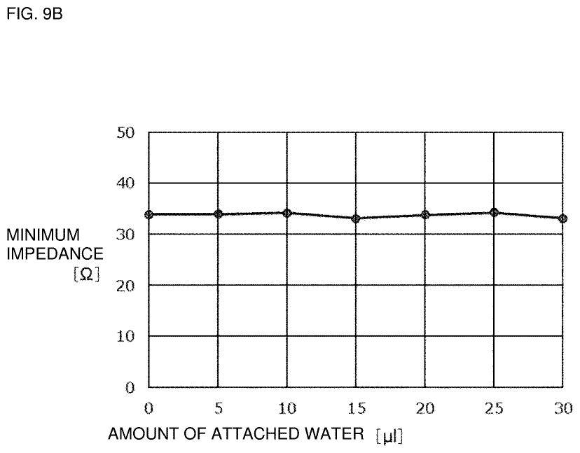

Before the temperature estimation step S1 in FIG. 4 will be described in the following, knowledge concerning the temperature estimation, which is a basis of the temperature estimation step S1, will be described with reference to FIGS. 8A, 8B, 9A, and 9B. The inventors of example embodiments of the present invention studied diligently the relationship between the vibration and temperature of the protective cover 2 and acquired the knowledge concerning the temperature estimation shown below, and eventually created a technical idea for estimating the temperature of the protective cover 2 by using the acquired knowledge.

FIG. 8A is a graph illustrating the relationship between the resonant frequency of the vibrator 12 in the high frequency band (hereinafter referred to as “high-frequency-band resonant frequency”) and temperature. FIG. 8B is a graph illustrating the relationship between the minimum impedance of the piezoelectric vibrator 15 in the high frequency band and temperature. In the graphs of FIGS. 8A and 8B, each black dot indicates an actually measured value.

From the graph illustrated in FIG. 8A, it can be seen that the high-frequency-band resonant frequency decreases with increasing temperature. However, it can be seen from the graph illustrated in FIG. 8B that correlation is not present between the minimum impedance of the piezoelectric vibrator 15 in the high frequency band and temperature. The relationship between the minimum impedance of the piezoelectric vibrator 15 in the high frequency band and temperature in FIG. 8B is not at least such a relationship that it decreases with increasing temperature as in FIG. 8A.

FIG. 9A is a graph illustrating the relationship between the amount of attached water and the high-frequency-band resonant frequency. FIG. 9B is a graph illustrating the relationship between the amount of attached water and the minimum impedance of the piezoelectric vibrator 15 in the high frequency band. In the graphs of FIGS. 9A and 9B, each black dot indicates an actually measured value. From the graph illustrated in FIGS. 9A and 9B, it can be seen that correlation is not present both between the amount of attached water and the high-frequency-band resonant frequency and between the amount of attached water and the minimum impedance of the piezoelectric vibrator 15 in the high frequency band.

Thus, only the high-frequency-band resonant frequency illustrated in FIG. 8A decreases with increasing temperature. Thus, the temperature of the protective cover 2 in the present example embodiment can be estimated by using the high-frequency-band resonant frequency. Specifically, in the high frequency band, the temperature T of the protective cover 2 can be estimated according to the following expression (1) using the resonant frequency fr of the vibrator 12.

$$T = A \cdot fr + B , \qquad ( 1 )$$

where A is a constant smaller than 0, and B is a constant larger than 0.

According to the actually measured values indicated in the graph of FIG. 8A, A=about −17, and B=about 9300, and the coefficient R of correlation between T and fr in expression (1) has a relationship R²=about 0.9973, for example.

For example, the relationship of (1) holds in the case in which the spring constant of a vibrating member has temperature dependence. The spring constant denotes how easy a member extends. In general, as for a member that becomes easier to extend with increasing temperature, the higher the temperature, the smaller the spring constant. In other words, as for a member that becomes easier to extend with increasing temperature, the higher the temperature, the lower the frequency of the vibration of the member.

As illustrated in FIGS. 9A and 9B, since the amount of attached foreign matter does not have a correlation with either the high-frequency-band resonant frequency or the minimum impedance of the piezoelectric vibrator 15 in the high frequency band, expression (1) holds even in the case in which foreign matter is attached to the light transmitter. Thus, whether the foreign matter is attached or not, expression (1) enables the temperature of the vibrating vibrator 12 and protective cover 2 to be estimated more accurately than conventional techniques.

### 2-2-2. Temperature Estimation Operation

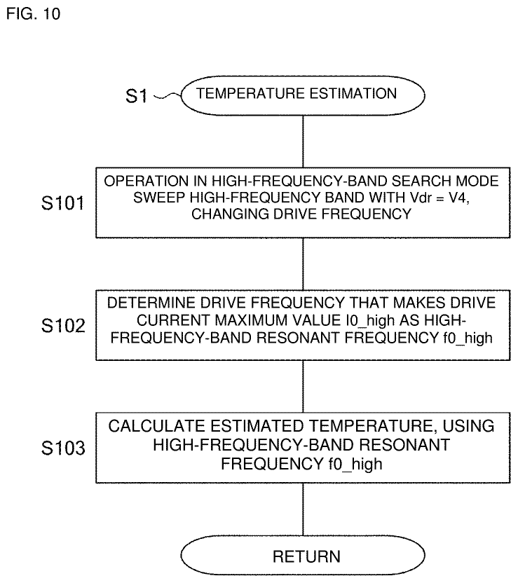

FIG. 10 is a flowchart for explaining an example of the temperature estimation step S1 in FIG. 4.

First, the signal processing circuit 20 causes the piezoelectric-vibrator driver 30 to operate the piezoelectric vibrator 15 in a high-frequency-band search mode (S101). The high-frequency-band search mode in step S101 is a mode for searching for a resonant frequency of the vibrator 12 in the high frequency band. In the high-frequency-band search mode, the piezoelectric-vibrator driver 30 sets the drive voltage Vdr of the piezoelectric vibrator 15 to V4 and applies alternating-current output signals to the piezoelectric vibrator 15, while changing the drive frequency f to sweep the high frequency band.

During the high-frequency-band search mode in step S101, the impedance detector 70 monitors the current value or the impedance of the piezoelectric-vibrator driver 30. Specifically, the impedance detector 70 measures the value of the current flowing in the piezoelectric-vibrator driver 30 or the impedance which is the reciprocal of the current value.

After step S101, the signal processing circuit 20 obtains the drive frequency f and the current value or impedance and determines the drive frequency f at which the current value becomes the maximum value 10 high or the drive frequency f at which the impedance becomes minimum, as the high-frequency-band resonant frequency f0_high (S102). In this way, the signal processing circuit 20 measures the maximum current value 10 high and the high-frequency-band resonant frequency f0_high corresponding to the maximum current value I0_high.

Next, the signal processing circuit 20 calculates an estimated temperature of the vibrator 12 and the protective cover 2 by using the high-frequency-band resonant frequency f0_high determined in step S102 (S103). Specifically, the signal processing circuit 20 substitutes the high-frequency-band resonant frequency f0_high measured in step S102 for fr in expression (1) and calculates the estimated temperature T.

### 2-2-3. Heating Operation Based on Result of Temperature Estimation

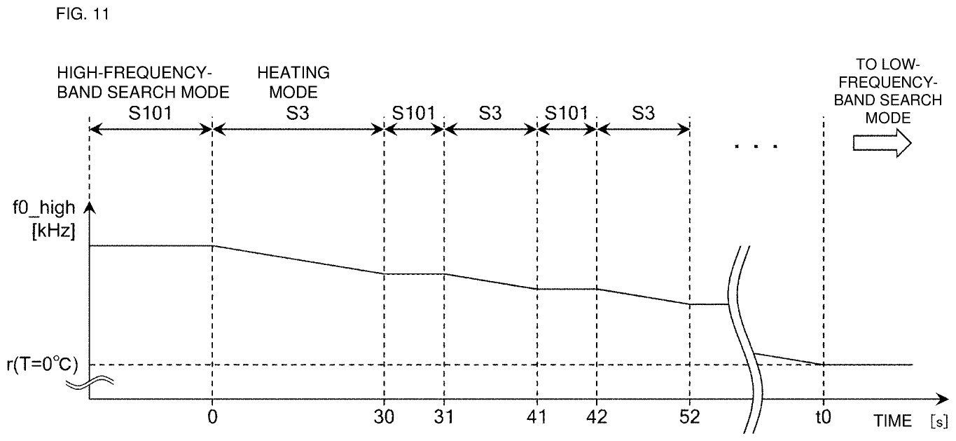

As illustrated in FIG. 4, the temperature estimation step S1 and the heating step S3 are repeated until the estimated temperature becomes about 0° C. or higher (No at S2). FIG. 11 is a schematic graph for explaining such a heating operation in the imaging unit 100.

In the graph of FIG. 11, the horizontal axis represents time [s], and the vertical axis represents the high-frequency-band resonant frequency f0_high [KHz]. The signal processing circuit 20 operates in the high-frequency-band search mode (S101), determines a high-frequency-band resonant frequency f0_high (S102), and calculates an estimated temperature (S103). If the estimated temperature is lower than about 0° C., the signal processing circuit 20 operates in the heating mode (S3) to increase the temperature of the protective cover 2. When the temperature of the protective cover 2 increases, the high-frequency-band resonant frequency f0_high decreases.

The operation time of the heating mode is, for example, about 30 seconds for the first time, and about 10 seconds for the second and subsequent times but is not limited to this example. The high-frequency-band search mode is executed, for example, about one second each time.

The signal processing circuit 20 repeats the operation described above until the estimated temperature becomes about 0° C. or higher (No at S2), in other words, until the high-frequency-band resonant frequency f0_high becomes lower than or equal to the frequency fr (T=0° C.) corresponding to about 0° C. In the graph of FIG. 11, f0_high=fr (T=0° C.) at time to. Thus, the signal processing circuit 20 transitions to the low-frequency-band search mode (S4) after time to.

### 3. Summary

As described above, a vibration device according to an example embodiment of the present invention includes the protective cover 2 which is an example of a light transmitter, the vibrator 12 which is an example of a vibrator to vibrate the protective cover 2, the piezoelectric-vibrator driver 30 to drive the vibrator 12, and the signal processing circuit 20 which is an example of a controller configured or programmed to control the piezoelectric-vibrator driver 30. The signal processing circuit 20 determines a high-frequency-band resonant frequency of the vibrator 12 (S102), according to the state of the piezoelectric-vibrator driver 30 obtained by changing the drive frequency of the piezoelectric-vibrator driver 30 within a high frequency band of about 100 kHz and higher (S101), and estimates the temperature of the protective cover 2 from the determined high-frequency-band resonant frequency (S103).

This configuration enables the temperature of the protective cover 2 to be estimated more accurately than in conventional techniques.

In the vibration device, if the estimated temperature of the protective cover 2 is lower than a specified value (Yes at S2), the signal processing circuit 20 may control the piezoelectric-vibrator driver 30 such that the piezoelectric-vibrator driver 30 causes the vibrator 12 to vibrate at a high frequency of about 100 kHz or higher (S3). If the estimated temperature of the protective cover 2 is higher than or equal to the specified value (No at S2), the signal processing circuit 20 may determine a low-frequency-band resonant frequency of the vibrator 12 (S4, S6), according to the state of the piezoelectric-vibrator driver 30 obtained by changing the drive frequency of the piezoelectric-vibrator driver 30 within a low frequency band lower than 100 kHz, and may control the piezoelectric-vibrator driver 30 such that the piezoelectric-vibrator driver 30 causes the vibrator 12 to vibrate at the low-frequency-band resonant frequency (S9, S11).

This configuration, if the temperature of the protective cover 2 is lower than the specified value, enables the temperature of the protective cover 2 to increase. This operation, for example, melts foreign matter such as ice and snow and makes it easy to remove the foreign matter attached to the protective cover 2.

After the vibrator 12 vibrates at a high frequency (S3), if the estimated temperature of the protective cover 2 is still lower than the specified value, the signal processing circuit 20 may determine again a high-frequency-band resonant frequency of the vibrator 12, according to the state of the piezoelectric-vibrator driver 30 obtained by changing the drive frequency of the piezoelectric-vibrator driver 30 within the high frequency band. The signal processing circuit 20 may estimate again the temperature of the protective cover 2 from the high-frequency-band resonant frequency determined again. If the temperature of the protective cover 2 estimated again is lower than the specified value, the signal processing circuit 20 may repeat controlling the piezoelectric-vibrator driver 30 such that the piezoelectric-vibrator driver 30 causes the vibrator 12 to vibrate at a frequency in the high frequency band for a specified period, after the specified period, determining again a high-frequency-band resonant frequency of the vibrator 12, according to the state of the piezoelectric-vibrator driver 30 obtained by changing the drive frequency of the piezoelectric-vibrator driver 30 within the high frequency band, and estimating again the temperature of the protective cover 2 from the high-frequency-band resonant frequency determined again, until the temperature of the protective cover 2 estimated again becomes higher than or equal to the specified value.

This configuration enables the temperature of the protective cover 2 to increase until the temperature of the protective cover 2 becomes higher than or equal to the specified value. This operation, for example, melts foreign matter such as ice or snow to make it easy to remove the foreign matter attached to the protective cover 2.

If the temperature of the protective cover 2 estimated again has become higher than or equal to the specified value, or if the estimated temperature of the protective cover 2 is higher than or equal to the specified value, the signal processing circuit 20 may determine a low-frequency-band resonant frequency of the vibrator 12, according to the state of the piezoelectric-vibrator driver 30 obtained by changing the drive frequency of the piezoelectric-vibrator driver 30 within a low frequency band lower than 100 kHz, and the signal processing circuit 20 may control the piezoelectric-vibrator driver 30 such that the piezoelectric-vibrator driver 30 causes the vibrator 12 to vibrate at the low-frequency-band resonant frequency.

With this configuration, vibrating the protective cover 2 the temperature of which has become higher than or equal to the specified value, for example, melts foreign matter such as ice or snow to make it easy to remove the foreign matter attached to the protective cover 2.

In the vibration device, the signal processing circuit 20 may estimate the temperature T of the protective cover 2 by using expression (1):

$$T = A \cdot fr + B , \qquad ( 1 )$$

where A is a constant smaller than 0, B is a constant larger than 0, and fr is the resonant frequency of the vibrator 12.

This configuration enables the temperature of the protective cover 2 to be estimated more accurately.

### MODIFIED EXAMPLES

Although example embodiments of the present invention have been described above in detail, the description above is merely an example of the present invention in every respect. Thus, various improvements and modifications can be made without departing from the scope of the present invention. For example, changes as described below are possible. In the following, elements the same as or similar to the ones in the above-described example embodiment are denoted by the same or similar symbols, and as for points the same as or similar to those in the above-described example embodiment, description thereof is omitted as appropriate. The following modified examples may be combined as appropriate.

### First Modified Example

Although in the example described in the above-described example embodiment, the temperature of the protective cover 2 is estimated from the high-frequency-band resonant frequency, the present invention is not limited to this example. For example, the vibration device may include a temperature sensor that measures the temperature of the protective cover 2 and may measure the temperature of the protective cover 2 by using the temperature sensor in addition to or instead of the temperature estimation step S1. This configuration enables the temperature of the protective cover 2 to be measured more accurately.

### Second Modified Example

Although in the example described in the above-described example embodiment, the signal processing circuit 20 determines whether foreign matter is present on the surface of the protective cover 2, and the degree of the foreign matter, according to the measurement results of the resonant frequency and the current value, the present invention is not limited to this example. For example, the signal processing circuit 20 may obtain images captured by the imaging device 5 and execute image processing on the images and may determine from the results of the image processing whether foreign matter is present on the surface of the protective cover 2, and the degree of the foreign matter.

For example, to determine that foreign matter is attached to the surface of the protective cover 2, the signal processing circuit 20 may take into account not only the change (change over time) in the resonant frequency fr and the change (change over time) in the current value I but also information on change over time in the images captured by the imaging device 5. In addition, to determine that foreign matter has been attached to the surface of the protective cover 2, the signal processing circuit 20 may combine the change (change over time) in the resonant frequency fr and the change over time in the images captured by the imaging device 5. Further, to determine that foreign matter has been attached to the surface of the protective cover 2, the signal processing circuit 20 may combine the change (change over time) in the current value Ir and the change over time in the images captured by the imaging device 5.

For example, if the change in the resonant frequency fr is larger than the absolute value of the threshold fth, and the integral of the brightness of the image captured by the imaging device 5 decreases, the signal processing circuit 20 may determine that foreign matter has been attached to the surface of the protective cover 2. This configuration enables the signal processing circuit 20 to take into account the change in the resonant frequency fr to distinguish a decrease in the integral of the brightness caused when the vehicle with the imaging unit 100, for example, goes into a tunnel from a decrease in the integral of the brightness caused when foreign matter is attached to the surface of the protective cover 2.

In addition, if the change in the resonant frequency fr and the change in the current value I are larger than the absolute values of the thresholds fth and Ith, respectively, and the integral of the brightness of the image captured by the imaging device 5 has largely decreased, the signal processing circuit 20 may determine that the foreign matter attached to the surface of the protective cover 2 is opaque matter such as mud. If the decrease in the integral of the brightness of the image captured by the imaging device 5 is small, the signal processing circuit 20 determines that the foreign matter attached to the surface of the protective cover 2 is transparent matter such as water. As described above, in the case in which the signal processing circuit 20 takes into account information on the change over time in the image captured by the imaging device 5, the signal processing circuit 20 can determine the kind of the foreign matter attached to the surface of the protective cover 2 more accurately.

### Third Modified Example

Although in the example described in the above-described example embodiment, if it is determined that the temperature of the protective cover 2 is lower than the specified lower-limit threshold (for example, about 0° C.) (if Yes at S2), the heating mode is performed, the present invention is not limited to this example. For example, if it is determined that the temperature of the protective cover 2 is higher than or equal to a specified upper-limit threshold, the signal processing circuit 20 may execute a process to prevent the temperature of the protective cover 2 from increasing or a process to cool the protective cover 2. An example of a process to prevent the temperature of the protective cover 2 from increasing is stopping driving the piezoelectric-vibrator driver 30 to stop the vibration of the piezoelectric vibrator 15, the vibrator 12, and the protective cover 2. An example of a process to cool the protective cover 2 is ejecting a cleaning liquid or another liquid such as a coolant to the protective cover 2 by using the cleaning nozzle 3.

With the present modified example, it is possible to prevent the temperature of the protective cover 2 or the entire imaging unit 100 from becoming excessively high and thus to achieve the safety of the imaging unit 100, the vehicle on which the imaging unit 100 is mounted, and objects and people around these.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration device comprising:
a light transmitter;
a vibrator to vibrate the light transmitter;
a driver to drive the vibrator; and
a controller configured or programmed to control the driver and determine a high-frequency-band resonant frequency of the vibrator according to a state of the driver obtained by changing a drive frequency of the driver within a high frequency band higher than or equal to about 100 kHz, and estimate a temperature of the light transmitter from the determined high-frequency-band resonant frequency.

2. The vibration device according to claim 1, wherein, if the estimated temperature of the light transmitter is lower than a specified value, the controller is configured or programmed to control the driver such that the driver causes the vibrator to vibrate at a high frequency of about 100 kHz or higher, and, if the estimated temperature of the light transmitter is higher than or equal to the specified value, the controller is configured or programmed to determine a low-frequency-band resonant frequency of the vibrator, according to a state of the driver obtained by changing the drive frequency of the driver within a low frequency band lower than about 100 kHz and control the driver such that the driver causes the vibrator to vibrate at the determined low-frequency-band resonant frequency.

3. The vibration device according to claim 1, wherein, if the estimated temperature of the light transmitter is lower than a specified value, the controller is configured or programmed to determine again a high-frequency-band resonant frequency of the vibrator, according to a state of the driver obtained by changing the drive frequency of the driver within the high frequency band, estimate again the temperature of the light transmitter from the high-frequency-band resonant frequency determined again, and, if the temperature of the light transmitter estimated again is lower than the specified value, to repeat controlling the driver such that the driver causes the vibrator to vibrate at a frequency in the high frequency band for a specified period, after the specified period, determine again a high-frequency-band resonant frequency of the vibrator according to a state of the driver obtained by changing the drive frequency of the driver within the high frequency band, and estimate again the temperature of the light transmitter from the high-frequency-band resonant frequency determined again, until the temperature of the light transmitter estimated again becomes higher than or equal to the specified value.

4. The vibration device according to claim 3, wherein
if the temperature of the light transmitter estimated again has become higher than or equal to the specified value, or if the estimated temperature of the light transmitter is higher than or equal to the specified value, the controller is configured or programmed to determine a low-frequency-band resonant frequency of the vibrator, according to a state of the driver obtained by changing the drive frequency of the driver within a low frequency band lower than about 100 kHz and control the driver such that the driver causes the vibrator to vibrate at the determined low-frequency-band resonant frequency.

5. The vibration device according to claim 2, further comprising:
a temperature sensor to measure the temperature of the light transmitter; wherein
if the temperature of the light transmitter measured by the temperature sensor is higher than or equal to the specified value, the controller is configured or programmed to determine the low-frequency-band resonant frequency of the vibrator, according to a state of the driver obtained by changing the drive frequency of the driver within a low frequency band lower than about 100 kHz and control the driver such that the driver causes the vibrator to vibrate at the determined low-frequency-band resonant frequency.

6. The vibration device according to claim 2, wherein
the light transmitter is located in a field of view of an imaging device; and
the controller is configured or programmed to obtain a captured image from the imaging device and execute image processing on the captured image, and if a result of the image processing indicates that foreign matter is not attached to a surface of the light transmitter, the controller is configured or programmed to determine the low-frequency-band resonant frequency of the vibrator, according to a state of the driver obtained by changing the drive frequency of the driver within a low frequency band lower than about 100 kHz and control the driver such that the driver causes the vibrator to vibrate at the determined low-frequency-band resonant frequency.

7. The vibration device according to claim 2, wherein the controller is configured or programmed to measure a drive current of the driver while changing the drive frequency of the driver within the low frequency band, and to determine the low-frequency-band resonant frequency according to the measured drive current value.

8. The vibration device according to claim 1, wherein the controller is configured or programmed to measure a drive current of the driver while changing the drive frequency of the driver within the high frequency band, and to determine the high-frequency-band resonant frequency according to the measured drive current value.

9. The vibration device according to claim 1, wherein
the controller is configured or programmed to estimate the temperature T of the light transmitter by using expression (1):
$$T = A \cdot fr + B , \qquad ( 1 )$$
where A is a constant smaller than 0, B is a constant larger than 0, and fr is a resonant frequency of the vibrator.

10. A vibration method performed by a vibration device including a light transmitter, a vibrator to vibrate the light transmitter, a driver to drive the vibrator, and a controller configured or programmed to control the driver, the vibration method comprising:
determining, in the controller, a high-frequency-band resonant frequency of the vibrator, according to a state of the driver obtained by changing a drive frequency of the driver within a high frequency band higher than or equal to about 100 KHz; and
estimating, in the controller, a temperature of the light transmitter from the determined high-frequency-band resonant frequency.

11. The vibration method according to claim 10, further comprising:
if the estimated temperature of the light transmitter is lower than a specified value, controlling, in the controller, the driver such that the driver causes the vibrator to vibrate at a high frequency of about 100 kHz or higher; and
if the estimated temperature of the light transmitter is higher than or equal to the specified value, determining, in the controller, a low-frequency-band resonant frequency of the vibrator, according to a state of the driver obtained by changing the drive frequency of the driver within a low frequency band lower than about 100 kHz and controlling the driver such that the driver causes the vibrator to vibrate at the determined low-frequency-band resonant frequency.

12. The vibration method according to claim 10, further comprising:
if the estimated temperature of the light transmitter is lower than a specified value, determining again, in the controller, a high-frequency-band resonant frequency of the vibrator, according to a state of the driver obtained by changing the drive frequency of the driver within the high frequency band, and estimating again the temperature of the light transmitter from the high-frequency-band resonant frequency determined again; and
if the temperature of the light transmitter estimated again is lower than the specified value, repeat controlling the driver such that the driver causes the vibrator to vibrate at a frequency in the high frequency band for a specified period;
after the specified period, determining again a high-frequency-band resonant frequency of the vibrator according to a state of the driver obtained by changing the drive frequency of the driver within the high frequency band; and
estimating again the temperature of the light transmitter from the high-frequency-band resonant frequency determined again, until the temperature of the light transmitter estimated again becomes higher than or equal to the specified value.

13. The vibration method according to claim 12, further comprising:
if the temperature of the light transmitter estimated again has become higher than or equal to the specified value, or if the estimated temperature of the light transmitter is higher than or equal to the specified value, determining, in the controller, a low-frequency-band resonant frequency of the vibrator, according to a state of the driver obtained by changing the drive frequency of the driver within a low frequency band lower than about 100 kHz and controlling the driver such that the driver causes the vibrator to vibrate at the determined low-frequency-band resonant frequency.

14. The vibration method according to claim 11, further comprising:
measuring the temperature of the light transmitter with a temperature sensor; and
if the temperature of the light transmitter measured by the temperature sensor is higher than or equal to the specified value, determining, in the controller, the low-frequency-band resonant frequency of the vibrator, according to a state of the driver obtained by changing the drive frequency of the driver within a low frequency band lower than about 100 kHz and controlling the driver such that the driver causes the vibrator to vibrate at the determined low-frequency-band resonant frequency.

15. The vibration method according to claim 11, further comprising:
locating the light transmitter in a field of view of an imaging device;
obtaining, in the controller, a captured image from the imaging device and executing image processing on the captured image; and
if a result of the image processing indicates that foreign matter is not attached to a surface of the light transmitter, determining, in the controller, the low-frequency-band resonant frequency of the vibrator, according to a state of the driver obtained by changing the drive frequency of the driver within a low frequency band lower than about 100 kHz and controlling the driver such that the driver causes the vibrator to vibrate at the determined low-frequency-band resonant frequency.

16. The vibration method according to claim 11, wherein
the determining the low-frequency-band resonant frequency according to a state of the driver includes measuring a drive current of the driver while changing the drive frequency of the driver within the low frequency band, and determining the low-frequency-band resonant frequency according to the measured drive current value.

17. The vibration method according to claim 10, wherein the determining the high-frequency-band resonant frequency according to a state of the driver includes measuring a drive current of the driver while changing the drive frequency of the driver within the high frequency band, and determining the high-frequency-band resonant frequency according to the measured drive current value.

18. The vibration method according to claim 10, further comprising:
estimating, in the controller, the temperature T of the light transmitter by using expression (1):
$$T = A \cdot fr + B , \qquad ( 1 )$$
where A is a constant smaller than 0, B is a constant larger than 0, and fr is a resonant frequency of the vibrator.
